(19) United States
(12) Patent Application Publication
(10) Pub. No.: US 2005/0255758 A1
(43) Pub. Date: Nov. 17, 2005

(54) Blade server system wtih a positioning design

(76) Inventors: Yuan-Chen Liang, Tao Yuan Shien (TW); Yung-Lung Liu, Panchiao City (TW); Chun-Yi Lien, Panchiao City (TW); Chao-Jung Chen, Taipei (TW)

Correspondence Address: RABIN & Berdo, PC, 1101 14TH STREET, NW, SUITE 500, WASHINGTON, DC, 20005, US

(21) Appl. No.: 11/103,578

(22) Filed: Apr. 12, 2005

(30) Foreign Application Priority Data
May 17, 2004 (TW) 93207688

(51) Int. Cl. H01R 4/48

(52) U.S. Cl. 439/835

(57) ABSTRACT

A blade server system includes a middle plane board and a server blade. The middle plane board includes a first connector having a number of slots and a positioning hole. The server blade includes a second connector, and by plugging the second connector into the first connector the server blade can be electrically connected with the middle plane board. The second connector includes a number of pins and a positioning stick. The pins are for correspondingly inserting into the slot, and the positioning stick is for inserting into the positioning hole. When the second connector is plugged into the first connector, the positioning stick is inserted into the positioning hole first and then the pins can be aligned with and inserted into the slots.

This application claims the benefit of Taiwan application Serial No. 93207688 filed May 17, 2004, the subject matter of which is incorporated herein by reference.

### BACKGROUND OF THE INVENTION

1. Field of the Invention

The invention relates in general to a blade server system, and more particularly to a blade server system having a positioning and guiding design for positioning the server blade onto the middle plane.

2. Description of the Related Art

Referring to FIG. 1, a partial sectional view of the mechanism of the coupling between a middle plane board and a server blade according to a conventional blade server system is shown. The blade server system 100 includes a middle plane board 110 and a server blade 120. The middle plane board includes a female connector 112, while the server blade 120 includes a male connector 122. By plugging the male connector 122 into the female connector 112, the server blade 120 can be electrically coupled with the middle plane board 110. The female connector 112 includes a number of slots 114, while the male connector 122 has a number of pins 124, including power pins and signal pins.

When the male connector 122 is plugged into the female connector 112, the pins 124 are correspondingly inserted into the slots 114 (as the arrow in the diagram shows) to complete electrical connection. However, the male connector 122 is normally a high density connector, i.e., the pins 124 have a large number. Without a suitable positioning design, the pins 124 are likely to be stricken to malfunction due to uneasy alignment during the connection of the female connector 112 and the male connector 122.

### SUMMARY OF THE INVENTION

It is therefore an object of the invention to provide a blade server system. A positioning stick and a positioning hole are respectively added onto the male and the female connectors to assure that the male connector can be electrically coupled to the female connector in safety during the process of connection.

The invention achieves the above-identified object by providing a blade server system including a middle plane board and a server blade. The middle plane board includes a first connector having a number of slots and a positioning hole. The server blade includes a second connector, and by plugging the second connector into the first connector, the server blade can be electrically connected with the middle plane board. The second connector includes a number of pins and a positioning stick. The pins are for correspondingly inserting into the slots, and the positioning stick is for inserting into the positioning hole. When the second connector is plugged into the first connector, the positioning stick is inserted into the positioning hole first and then the pins can be aligned with and inserted into the slots.

The positioning stick includes a guiding head and a main body. The guiding head is for guiding the main body to be smoothly inserted into the positioning hole when the second connector is plugged into the first connector. The guiding head includes a front end and a rear end. The rear end is connected with the main body, and the guiding head smoothly contracts from the rear end to the front end. When the positioning stick is inserted into the positioning hole but the main body is not exactly aligned with the positioning hole, the guiding head enters the positioning hole through the front end first, and then moves along the edge of the positioning hole to guide the main body to be aligned with and inserted into the positioning hole. The positioning stick and the positioning hole are respectively disposed at one side of the pins and the slots. The positioning stick projects from all of the pins, while the depth of the positioning hole is at least deep enough for the pins to be inserted into the right position of the slots when the positioning stick is inserted into the positioning hole. So, the design of the positioning stick and the positioning hole effectively prevents the pins of the second connector from being stricken and damaged during connection.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a partial sectional view of the mechanism of the coupling between a middle plane board and a server blade according to a conventional blade server system;

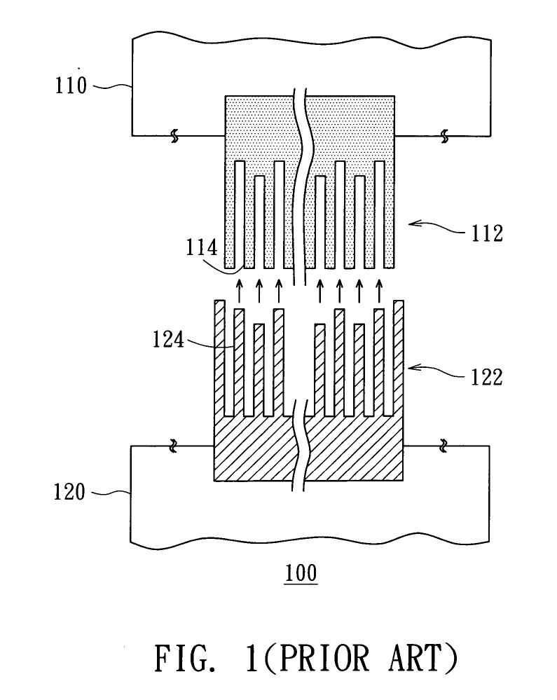

FIG. 2A is a partial sectional view of the mechanism of the coupling between a middle plane board and a server blade of a blade server system according to a preferred embodiment of the invention; and

FIGS. 2B-2D are sectional views of a positioning stick 226 and a positioning hole 216 in FIG. 2A, which are not exactly aligned with each other.

### DETAILED DESCRIPTION OF THE INVENTION

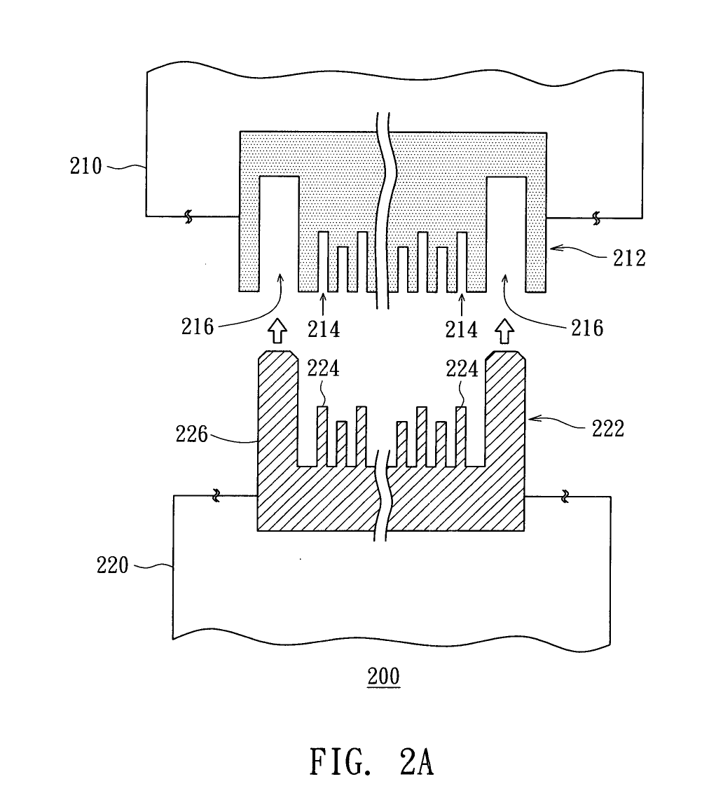

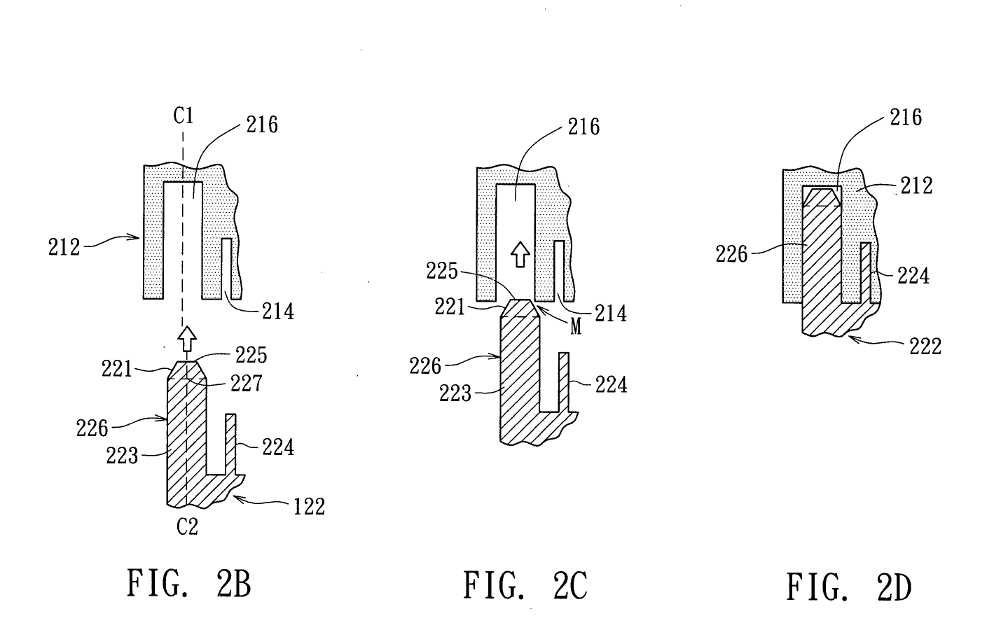

Referring to FIG. 2A, a partial sectional view of the mechanism of the coupling between a middle plane board and a server blade of a blade server system according to a preferred embodiment of the invention is shown. The blade server system 200 includes a middle plane board 210 and a server blade 220. The middle plane board 210 includes a first connector 212 having a number of slots 214 and a positioning hole 216. The server blade 220 includes a second connector 222. By plugging the second connector 222 into the first connector 212, the server blade 220 can be electrically connected with the middle plane board 210. The second connector 222 includes a number of pins 224 and a positioning stick 226. The pins 224 are for correspondingly inserting into the slots 214, while the positioning stick 226 is for inserting into the positioning hole 216 (as the arrow in the diagram shows).

The positioning stick 226 and the positioning hole 216, which can be made of plastics for example, are respectively disposed around, outside, and at least at one side of the pins 224 and the slots 214. The positioning stick 226 projects higher than all of the pins 224, while the depth of the positioning hole 216 is at least deep enough for the pins 224 to be inserted into to the right position of the slots 214 when the positioning stick 226 is inserted into the positioning hole 216. So, before the second connector 222 is plugged into the first connector 212, the positioning stick 226 is plugged into the positioning hole 216 first, enabling the pins 224 to be aligned with and inserted into the slots 214 and avoiding the damage of pins as would occur in prior art.

Referring to FIGS. 2B-2D, sectional views of the positioning stick 226 and the positioning hole 216 in FIG. 2A, which are not exactly aligned with each other are shown. As shown in FIG. 2B, the positioning stick 226 includes a guiding head 221 and a main body 223. The guiding head 221, which guides the main body 223 to be smoothly inserted into the positioning hole 216, includes a front end 225 and a rear end 227. The rear end 227 is connected with the main body 223, while the guiding head 221 smoothly contracts from the rear end 227 to the front end 225. The main body 223 can be cylinder-shaped, the positioning hole 216 is a cylinder hole, and the guiding head 221 is semi-coned.

As shown in FIG. 2C, when the positioning stick 226 is inserted into the positioning hole 216 and the main body 223 is not exactly aligned with the positioning hole 216, that is, the central line C2 of the positioning stick 226 slightly deviates from the central line C1 of the positioning hole 216, since the cross section of the front end 225 of the guiding head 221 is smaller than the rear end 227, the guiding head 221 can enter the positioning hole 216 through the front end 225 and move along the bevel edge M of the positioning hole 216 to guide the main body 223 to be aligned with and inserted into the positioning hole 216. In the meanwhile, the pins 224 can be correctly inserted into the slots 214 as shown in FIG. 2D. So, the design of the positioning stick 226 and the positioning hole 216 effectively prevents the pins 224 of the second connector 222 from being stricken and damaged during connection.

According to the above-mentioned preferred embodiment, the blade server system of the invention has the following advantages. By incorporating the positioning design of the positioning hole and the positioning stick with the guiding head design of the positioning stick, the deviation of alignment which occurs when the second connector is not exactly aligned with the first connector can be calibrated, and the second connector pins can be guided and inserted into the slots of the first connector after the positioning stick is inserted into the positioning hole, effectively preventing the malfunction of connector pins due to collision as would occur in prior art.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A blade server system, comprising:
a middle plane board, comprising a first connector, wherein the first connector comprises a plurality of slots and a positioning hole; and
a server blade, comprising a second connector, wherein by plugging the second connector into the first connector the server blade can be electrically connected with the middle plane board, and the second connector comprises:
a plurality of pins, for correspondingly inserting into the slots; and
a positioning stick, for inserting into the positioning hole;
wherein when the second connector is plugged into the first connector, the positioning stick is inserted into the positioning hole first and then the pins can be aligned with and inserted into the slots.

2. The blade server system according to claim 1, wherein the positioning stick comprises a guiding head and a main body, when the second connector is plugged into the first connector, the guiding head guides the main body to be smoothly inserted into the positioning hole.

3. The blade server system according to claim 2, the guiding head comprises a front end and a rear end, wherein the rear end connects the main body, and the guiding head smoothly contracts from the rear end to the front end.

4. The blade server system according to claim 3, wherein when the positioning stick is inserted into the positioning hole, and the main body is not exactly aligned with the positioning hole, the guiding head enters the positioning hole through the front end first and moves along the edge of the positioning hole to guide the main body to be aligned with and inserted into the positioning hole.

5. The blade server system according to claim 4, wherein the main body is cylinder-shaped, the positioning hole is a cylinder hole, and the guiding head is semi-coned.

6. The blade server system according to claim 1, wherein the positioning stick and the positioning hole are respectively disposed at one side of the pins and the slots.

7. The blade server system according to claim 1, wherein the positioning stick projects from all of the pins.

8. The blade server system according to claim 1, wherein the depth of the positioning hole is at least deep enough for the pins to be inserted into the right position of the slots when the positioning stick is inserted into the positioning hole.

9. The blade server system according to claim 1, wherein the positioning stick and the positioning hole are made of plastics.
